(19) United States
(12) Patent Application Publication
(10) Pub. No.: US 2010/0017820 A1
(43) Pub. Date: Jan. 21, 2010

(54) REALTIME INSERTION OF VIDEO CONTENT IN LIVE BROADCASTING

(75) Inventors: Haresh Thevathasan, Milton (CA); Don Hutchison, Toronto (CA); Drew McDougall, Toronto (CA)

Correspondence Address: OCCHIUTI ROHLICEK & TSAO, LLP, 10 FAWCETT STREET, CAMBRIDGE, MA, 02138, US

(73) Assignee: Telephoto Technologies Inc.

(21) Appl. No.: 12/175,967

(22) Filed: Jul. 18, 2008

(51) Int. Cl. H04N 7/025; H04N 7/173

(52) U.S. Cl. 725/35; 725/32; 725/114

(57) ABSTRACT

A system and method relates to providing a set of pre-recorded video content for inclusion into one or more locations in a video broadcast having sport content of a live sporting event, the video broadcast for production during the live sporting event.

### FIELD OF THE INVENTION

This invention relates to distribution of video content over a communications network.

### BACKGROUND OF THE INVENTION

The effective targeting of advertising content is an ever-increasing challenge. It is well known that content-targeted advertising is associated with optimized product placement, based on the target audience, and is particularly interested in the associated media content and location within the media content that the advertising is placed. In pre-recorded television programming, the advertisers feature their advertisements at selected times within a pre-recorded television program. Advertising content and placement is determined well in advance of the broadcast of the television programming and there is no need to dynamically change the advertising content and/or the times at which the advertising content is broadcast, due to the predictable timing of the typical pre-recorded television programming.

Unlike typical pre-recorded television programming which has standard uniform broadcast seasons, each and every sport venue in horse racing has its own unique broadcast season determined by its own unique live racing calendar. As a result the start and end dates of the broadcast schedule of each sport venue varies throughout the year.

However, effective targeting of advertising content for live sporting events, e.g. horse racing, is problematic. For example, at each race track the programming of the racing can be dynamic and even random. The timing of the actual race and by extension the racing cycle around the race can be subject to uncontrollable and unforeseen flux inherent in the live TV production of animals. Timing is also subject to the discretion and interests of the local racetrack management. For example, the timing of races may be affected by such things as the health &/or behaviour of the horses, race inquiries, judicial review of race results, interruptions of the betting information provided by Tote companies, etc. Further, track management has the discretion of delaying the start of the race to prolong betting of that race as well as to reposition the race due to overlapping programming of other races being held at other racetracks. Accordingly, trying to feature advertisements in the live broadcast of live sporting events cannot be scheduled by time of day and/or specific sporting event (e.g. a selected race) considerations. It may well be that a particular race is delayed or even cancelled on a particular day. Further, the number of opportunities to position advertising content within a particular race can be variable, due to unforeseen circumstances.

It is recognised that Industry figures indicate that of the total revenue a horse track receives, attendees physically at their track, betting on their live horse race, generate approximately ten percent. The remaining percent (e.g. ninety percent) can be generated from attendees at their track betting on simulcast races of other tracks as well as attendees at other tracks betting on their track. Often, track management will delay the start of live racing at their track in order that their racing does not coincide with races at other tracks. The goal in doing this is to increase their total revenue by increasing the opportunity for people to bet more—both on their track's races but also on races at other tracks that are simulcast at their track during the live racing. One complication for optimizing the revenue generation of advertising content is that the sport venues can be located in different time zones, resulting in member sport venues beginning & ending racing at different times.

In view of the dynamic nature of broadcasting live sporting events, it is recognised that a dynamic advertising system is needed to accommodate for the dynamic nature of the sporting events themselves.

### SUMMARY OF THE INVENTION

It is an object of the present invention to provide a dynamic supplementary video content distribution environment to obviate or mitigate at least some of the above-presented disadvantages.

A first aspect provided is a system for providing a set of pre-recorded video content for inclusion into one or more locations in a video broadcast having sport content of a live sporting event, the video broadcast for production during the live sporting event, the system comprising: a content server for assembling the set of pre-recorded video content and a set of associated insertion instructions, the insertion instructions having a plurality of insertion information including at least one predefined trigger event assigned to each identified video in the video content, the predefined trigger event defined as a sport activity known to occur in the live sporting event; and a content client configured for coupling to the content server over a communications network, the content client further configured for receiving the set of pre-recorded video content and an order of the videos of the pre-recorded video content corresponding to the set of associated insertion instructions and for indicating selected contents of the set of pre-recorded video content to a user, the content client having an insertion control operable by the user for initiating release of a video of the set of pre-recorded video content to production equipment for producing the video broadcast, the video having an assigned trigger event matching a current sport activity of the live sporting event; wherein the production equipment inserts the video into the video broadcast at a location corresponding to the current sport activity.

A second aspect provided is a method of providing a set of pre-recorded video content for inclusion into one or more locations in a video broadcast having sport content of a live sporting event, the video broadcast for production during the live sporting event, the method comprising: assembling the set of pre-recorded video content and a set of associated insertion instructions, the set of pre-recorded video content having an order of the videos of the pre-recorded video content corresponding to the set of associated insertion instructions, the set of associated insertion instructions having a plurality of insertion information including at least one predefined trigger event assigned to each identified video in the video content, the at least one predefined trigger event defined as a sport activity known to occur in the live sporting event; transmitting said set of pre-recorded video content and set of associated insertion instructions over a communications network to a sport venue having a content client configured for initiating release of a video of the set of pre-recorded video content to production equipment for producing the video broadcast; generating update material of at least one of previously transmitted said set of pre-recorded video content or previously transmitted said set of associated insertion instructions; and transmitting the update material to the sport venue; wherein the production equipment inserts said video into the video broadcast at a location corresponding to the respective sport activity defined by the assigned predefined trigger event, the manner of insertion based on information contained in the update material.

A third aspect provided is a method for providing a set of pre-recorded video content for inclusion into one or more locations in a video broadcast having sport content of a live sporting event, the video broadcast for production during the live sporting event, the method comprising: receiving the set of pre-recorded video content and a set of associated insertion instructions, the set of pre-recorded video content having an order of the videos of the pre-recorded video content corresponding to the set of associated insertion instructions, the insertion instructions having a plurality of insertion information including at least one predefined trigger event assigned to each identified video in the video content, the predefined trigger event defined as a sport activity known to occur in the live sporting event; indicating selected contents of the set of pre-recorded video content to a user having knowledge of a sport activity status of the live sporting event; and receiving instructions from an insertion control operable by the user for initiating release of a video of the set of pre-recorded video content to the production equipment for producing the video broadcast, the video having an assigned trigger event matching a current sport activity of the live sporting event; wherein the production equipment inserts the video into the video broadcast at a location corresponding to the current sport activity.

### BRIEF DESCRIPTION OF THE DRAWINGS

Exemplary embodiments of the invention will now be described in conjunction with the following drawings, by way of example only, in which:

FIG. 1 is a block diagram of components of video content distribution environment;

FIG. 2 shows an example broadcast of a sports venue of the environment of FIG. 1;

FIG. 3 is a block diagram of an example configuration of a content server of the environment of FIG. 1;

FIG. 4 is an example insertion instructions of the environment of FIG. 1;

FIG. 5 is an example content of an insertion schedule for a plurality of sport venues of the environment of FIG. 1;

FIG. 6 is a block diagram of a content client of the environment of FIG. 1;

FIG. 7 is an example operation of the environment of FIG. 1; and

FIG. 8 is a block diagram of an example computing device of the components of the environment of FIG. 1.

### DETAILED DESCRIPTION OF THE PREFERRED EMBODIMENT(S)

### Video Content Distribution Environment 10

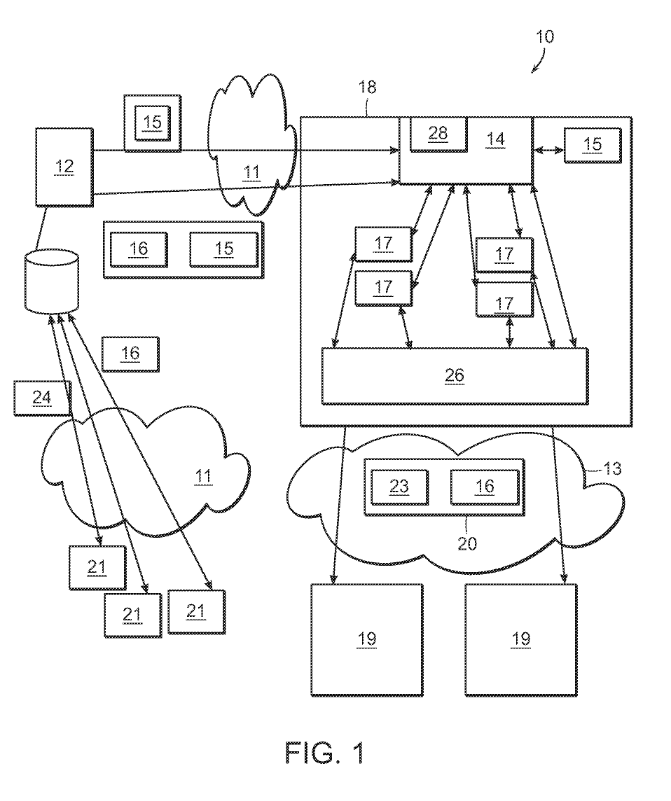

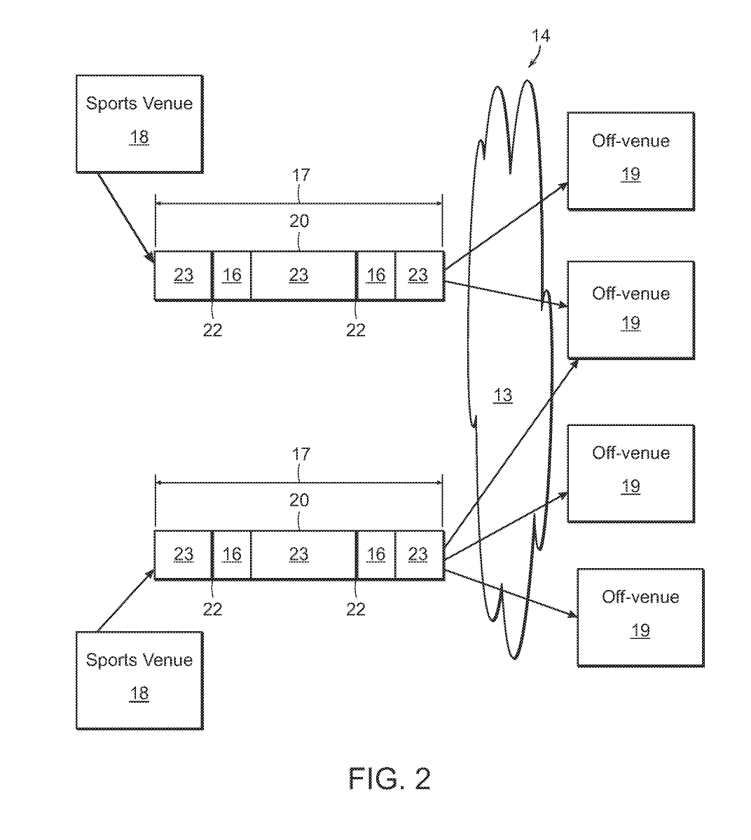

Referring to FIG. 1, shown is a video content distribution environment 10 for coordinating the network based delivery and playback infrastructure of pre-recorded supplementary video content 16 (e.g. having a plurality sequential images that contain the same or different image content, for example the same image is in each of the sequential images and/or a different image is in each of the sequential images) for insertion into live broadcast(s) 20 of a plurality of sporting events 17. The environment has one or more content servers 12 coupled over a communications network 11 (e.g. the Internet) to a plurality of content clients 14 located at corresponding sport venues 18 (e.g. racetracks, arenas, stadiums, etc). The content servers 12 provide recorded supplementary video content 16 (e.g. commercials) and related sport venue insertion instructions 15 to the content clients 14 for subsequent insertion of the supplementary video content 16 into live video broadcasts 20 of sporting events 17 held at the sport venues 18. Accordingly, the video broadcasts 20 include sporting content 23 and inserted supplementary video content 16 placed at defined trigger events 22 (see FIG. 2) of the sporting event 17. The live broadcasts 20 can be communicated over the communications network 11 and/or over alternative broadcast network(s) 13 such as but not limited to satellite broadcasting to off-venue (e.g. off-track) locations 19 for viewing by a plurality of viewers wanting to view and potentially wager on the broadcast sporting events 17. It is recognised that the inclusion of the video content 16 in the video broadcast 20 can be in substitution of live sport content 23 (see FIG. 2) and/or as a combined display with the live sport content 23 (e.g. a split screen or other screen display such as an L bracket screen).

Referring again to FIG. 1, it is recognised that the supplementary video content 16 can contain subject matter (e.g. product/service advertisements) relevant to content providers 21 that submitted the supplementary video content 16 (for example video materials used to make the supplementary video content 16) to the content servers 12, as further described below. The content providers 21 (e.g. product/service advertiser, advertisement agency, etc.) can also obtain reports 24 containing confirmation information of the supplementary video content 16 broadcast particulars from the content server 12. For example, the content providers 21 can receive the report 24 at an appropriate time interval (e.g. daily, at the end of an ad campaign etc.) that can contain the time and date of the supplementary video content 16 broadcast and/or at which trigger event 22 (see FIG. 2) the video content 16 was inserted into the live broadcast 20.

It is recognised that unlike scheduled television programming, i.e. recorded programming, the actual “timing” for the spot/point at which the supplementary video content 16 is inserted in to the live video broadcast can vary due to the implicit variability of timing for live sports events 17. Accordingly, the specification of the event trigger 22 in the sport venue insertion instructions 15 facilitates placement of the supplementary video content 16 at a event location in the sports event 17 that is desired by the respective content provider 21 as further described below. The event location in the live sports event 17 is defined by the trigger event 22, as further described below.

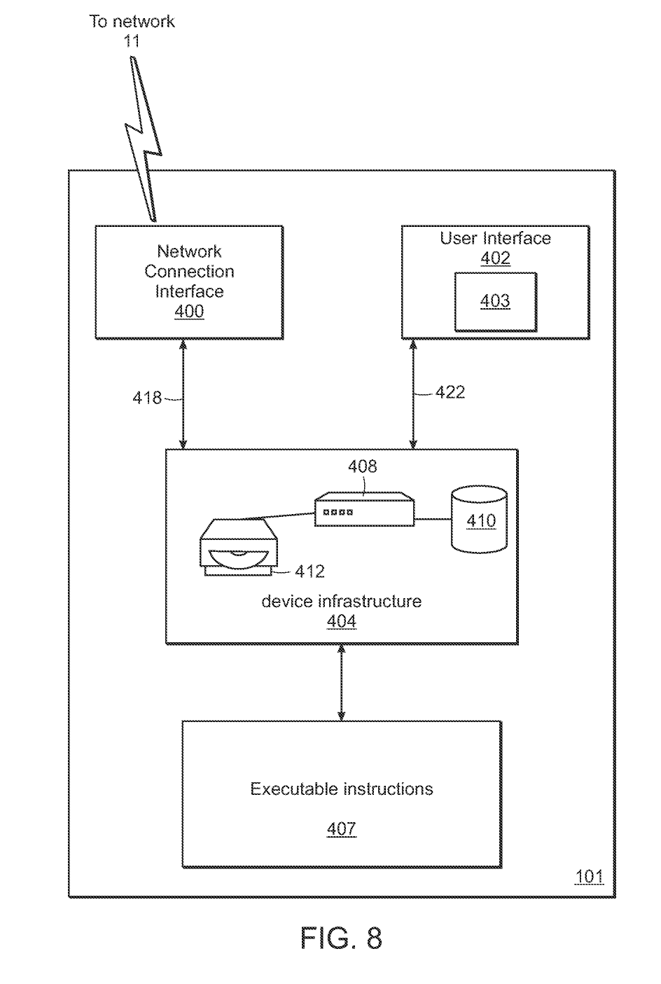

Communication between the content server 12, the content clients 14, the sport venues 18, content providers 21, and the off venue locations 19 is facilitated via one or more communication networks 11,13 (such as intranets and/or extranets—e.g. the Internet), for example implemented by a user through a user interface 402 (see FIG. 8). The environment 10 can include multiple content servers 12, multiple content clients 14, multiple sport venues 18, multiple content providers 21, multiple off-venue locations 19 and one or more coupled communication networks 11,13 as desired.

One example of the environment 10 is where the closed circuit TV broadcast signal 20 of each sport venue 18 (via their corresponding production equipment 26) is uplinked to a broadcast satellite (e.g. network 13) which distributes the TV broadcast signals 20 across North America and parts of south America to approximately 1,100 on and off-venue locations 19. It is recognised that the broadcast signal 20 can be distributed by signal transmission networks other than satellite and to geographical locations other than mentioned above. It is recognised that broadcast 20 of the sporting event 17 can also be done via non-closed circuit broadcasting including but not limited to the world wide web. Accordingly, the locations 19 can be located at non-sporting venues as well as at other sporting venues not hosting the particular live sporting event 17 that is included in the broadcast 20. In any event, it is recognised that the locations 19 are locations that are not hosting the live sporting event 17 shown via the broadcast 20.

One example of the environment 10 is applied to out-of-home advertising (also referred to as OOH) that is configured to provide video content advertising that reaches the consumer while he or she is outside the home. This is in contrast to broadcast, print, or Internet advertising, which is delivered to viewers for home or office viewing.

### Sport Venue 18

Referring again to FIG. 1, each of the sport venues 18 is configured to produce and transmit the video broadcast 20 of each of the sporting events 17 held at the respective sport venue 18. The sport venue has video production equipment 26 (e.g. cameras, etc.) for producing a live video stream(s) (including synchronized audio content) of the various sporting events 17 taking place on any particular day. As discussed above, the sport venue 18 also has the content client 14 for coordinating the insertion of the received video content 16 into the video broadcast 20, according to the corresponding sport venue insertion instructions 15. The content server 12 sends, via the network 11, the sport venue insertion instructions 15 specifying what video content 16 is to be played at the sport venue 18 (e.g. track) and where (e.g. the race, and the position in the race cycle) the video content 16 are to be played, as defined by the trigger event(s) 22 associated with each of the video content 16. The technical director or other production manager (e.g. content client 14 user) coordinates the following of the sport venue insertion instructions 15 (implemented via the insertion control 28 coupled to the content client 14) so that the video content 16 are played according to a network schedule 202.

### Sporting Event 17 and Sport Venue 18 Information

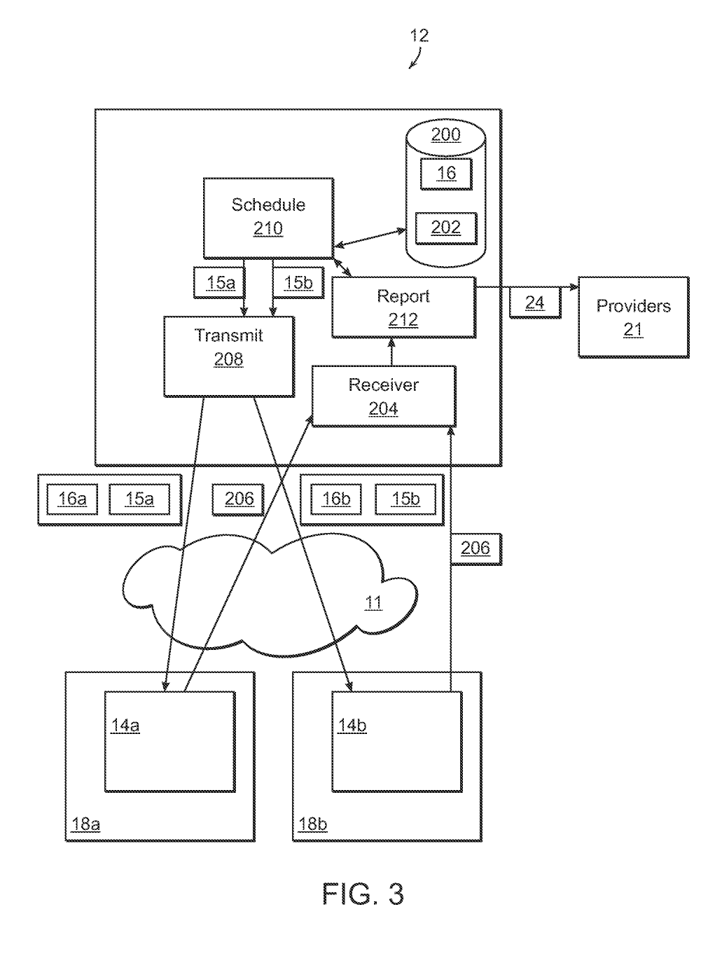

After the sporting events 17 (e.g. race day), the sporting venue 18 coordinates the supply of insertion reports 206 (see FIG. 3) to the content server 12. The insertion reports 206 can include information such as but not limited to: a list of the video content 16 that were inserted into the sporting venue's 18 TV broadcast 20 production for the respective sporting events 17, the track name of the sporting venue 18, the commercial name of the sporting venue 18, the date & time the video content 16 was played, and/or the event location (e.g. position in a race cycle as defined by the trigger events 22) that the video content 16 was inserted into the broadcast 20.

The sporting event 17 can be defined as a competition/rivalry (real and/or simulated—e.g. entertainment such as staged wrestling) including physical activity (and/or motorized activity) between individuals or groups of individuals (e.g. teams), human or other animal.

The content client 14 can also be used to send to the content server 12 a detailed list of the name and address (e.g. including street address, city, and state/province) of each unique sport venue 18 that receives and plays the TV broadcast signal 20 containing the video content 16, including any off-track wagering outlets, any casino race books that receive the broadcast signal 20, simulcast track partners and the off-track wagering outlets and casino race books of the simulcast track partners that receive and play the broadcast signal 20.

For example, a video content 16 (e.g. advertisement) spot/location is a specific location or point within the sporting event 17 (e.g. race cycle) where one or more video content 16 may be played or otherwise inserted into the broadcast 20 in substitution of or in tandem with the live sport content 23 that is ongoing. The spot/locations are specified by the trigger events 22 in the sport venue insertion instructions 15. A race cycle can be defined as the sporting event 17 interval from the pre-race information and the presentation of the morning line odds to the final race replay which occurs just before the pre-race information of the subsequent race. The video content 16 can be defined as one or more commercials, which could vary in length (e.g. from 5 seconds to 60 seconds). The number of trigger events 22 per sporting event 17 can be defined as one, two, three, four, or more spots per sporting event 17 (e.g. race cycle).

Loosely defined, a race cycle (e.g. a sport event 17 cycle) is the interval between the start of adjacent races (e.g. sport events 17). For example, the actual horse race can be less than 2 minutes of the entire race cycle. A typical thoroughbred track 18 races between 8 and 10 races 17 in a race day and lasts approx 4 to 5 hours. A typical harness track 18 races between 10 and 15 races 17 in a race day and lasts about 5 hours. Typically a track 18 begins racing either in early afternoon e.g. 12 to 1:00 pm, early evening e.g. 4 to 5:00 pm or later in the evening e.g. 7:00 pm. The sport venues 18 can be located in different time zones, resulting in member sport venues 18 beginning & ending racing at different times during a race day, beginning at about 12:00 pm EST and ending at about 1:30 am EST.

The race cycle of a standard bred race (e.g. sporting events 17),can be approximately 20 minutes in length. One example of video content 16 capacity per race cycle for standard bred races 17 is four (4) ad 16 spots totalling 2.0 minutes of multiple ads 16 of various lengths, as defined via the trigger events 22 and the length of each ad 16. The race cycle of a thoroughbred race 17 is assumed to be 30 minutes, for example, with a capacity per race cycle for thoroughbred races of four (4) ad 16 spots totalling 2.5 minutes of multiple ads 16 of various lengths.

Other example configurations of sporting events 17 can be such that each sport venue 18 has its own unique daily sporting event 17 (e.g. racing) schedule and duration of race day. In the context of the overall environment 10, the time at which a member sport venue 18 begins and ends their race day can vary throughout the day, which means that the available video content 16 inventory in the library 200,300 and the scheduling of the video content 16 can be dynamically updated throughout any given race day.

It is recognised that in view of the above, the schedule information 202 can include information on a plurality of sporting events 17 to be held at a plurality of sporting venues 18 and including a plurality of trigger events 22 of each of the plurality of sporting events 17, as well as any video content 16 associated with the trigger events 22.

### Video Broadcast 20

Referring to FIG. 2, the video broadcasts 20 include a plurality of video/audio segments for live sporting content 23 with inserted previously recorded supplementary video content 16 placed at defined trigger events 22 (see FIG. 2) of the sporting event 17. One or more supplementary video contents 16 can be inserted between adjacent broadcasted segments of the live sporting content 23, according to the sport venue insertion instructions 15 and/or the instruction of a user of the content client 14. It is recognised that the video production equipment 26 is used to switch the video stream if the broadcast 20 between captured video 23 of the sporting event 17 and the supplementary video content 16. Examples of the video broadcasts 20 can include races such as but not limited to: animal sports such as horse racing (including harness, quarterhorse and thoroughbred racing), greyhound racing, and/or other animal racing; human sports such as cycling, and/or other athletics (e.g. boxing); and/or motor sports such as auto racing, motorcycle racing, stock car racing, and/or drag racing. It is recognised that the video broadcast 20 of the live video content 23 can be time delayed as compared to the actual timing of the sports event 17, for example due to transmission delays inherent in broadcast and reception of the video broadcast 20 over the network 11,13. Further, in the event that there is betting/wagering on the sporting events 17 (e.g. horse races), the broadcast 20 to simulcast venues (e.g. locations 19) cannot be delayed more than a predefined delay period (e.g. between 8 and 12 seconds) of the actual live sporting event 17. In any event it is recognised that the broadcast 20 may be received in real-time by the locations 19, may be delayed up to a predefined delay period, or may be stored for subsequent replay at a later time/date (e.g. replay/rebroadcast of a taped sporting event such as a hockey game).

### Production of the Video Broadcast 20

Referring to FIG. 1, it is recognised, as further described below, that the supplementary video content 16 is not automatically inserted into the live production of the sport content 23 according to specified times and dates. Instead, the production user of the production equipment 26 and the content client 14 has manual/semi-automatic control over the supplementary video content 16 insertion process, and is responsible for initiating the switching of the supplementary video content 16 feed between broadcast segments (e.g. sport content 23) of the sport event 17, based on the specified trigger events 22 in the respective sport venue insertion instructions 15 associated with the supplementary video content 16. The use of an insertion control 28 (e.g. a start button) by the production user for initiating the insertion of the supplementary video content 16 into the video broadcast 20 provides for the production user to retain manual control over the production of the video broadcast 20.

For example, the supplementary video content 16 will become inserted into the broadcast 20 only when the insertion control 28 of the content client 14 (e.g. a set top box (STB)) in the production control room of the sport venue 18 is activated (e.g. pressed) by the technical director (e.g. production user), followed by the technical director switching/selecting (e.g. via a control panel of the production equipment 26) the supplementary video content 16 in substitution of or in tandem with the sports content 23 of the ongoing sporting event 17. Once the specified (as per the sport venue insertion instructions 15) supplementary video content 16 sequence has been completed, the technical director switches the production content of the video broadcast 20 back to the live sports content 23 of the ongoing sporting event 17. It is recognised that in the case of an occurrence of an unscheduled event in the sporting event 17, the production equipment 26 and/or the insertion control 28 can also be used to halt or otherwise suspend the playing of the supplementary video content 16 and the technical director can reintroduce (e.g. select) the sports content 23 of the ongoing sporting event 17 to the video broadcast 20. As further described below, the content client 14 is used to record the play history of the supplementary video content 16, including information such as but not limited to: the time and date of the supplementary video content 16 broadcast; at which trigger event 22 (see FIG. 2) the video content 16 was inserted into the live broadcast 20; and/or whether the supplementary video content 16 was played to completion (e.g. the playback of the recorded supplementary video content 16 was not interrupted).

The ad creative for each video content 16 can be transmitted as an electronic file from the content server 12 to the content client 14 at the member sport venue 18, where the video content 16 can be stored in the library 300. This transmission can be done as a batch file (e.g. at night at night when the member sport venues 18 are not operating the sporting events 17) and/or as dynamic updates during operation of the sporting events 17, as desired. For example, the video content 16 file, which can be sent initially, can be received well in advance of it being scheduled to play. Since the content video 16 file is saved in the library 300 in the content client 14 and the video content 16 can be available whenever it is required in the future. The content video 16 can be archived indefinitely for future play. Alternatively, new video content 16 can be played within receipt (e.g. within minutes) of being transmitted to the content client 14.

### Content Provider 21

Referring to FIG. 1, the content provider 21 uses the content server 12 to manage and deliver supplemental video content 16 (e.g. advertising) into the processes and infrastructure of the sport venues 18 coupled to the network 11,13. The content provider 21 provides the supplemental video content 16 to the content server 12 in an appropriate format (e.g. MPeg 2, SD Full D1 NTSC). If desired, the content server can convert file format of the supplied (from the content provider 12) supplemental video content 16 for compatibility with the broadcast production equipment 26 of the sport venues 18.

Once submitted, the supplemental video content 16 is stored in the library 200 of the content server 12 and/or in the client library 300 of the content client 14. Further the content provider 21 also receives reports 24 (e.g. at the end of each ad campaign) listing the time of day and date the ad 16 was played in the broadcast(s) 20 as well as the trigger event 22 and/or sport event location associated with the played ad 16.

### Content Server 12

The Content Server 12 manages sport venue insertion schedules 15 at the micro level for each sport venue 18 and at the macro level for the network-wide aggregation. The advertiser (e.g. content provider 21) is typically interested in the schedule at the macro level. The content server 12 is configured to generate the pre-recorded video content 16 and the set of associated insertion instructions 15 for each of the content clients 14 to include the set of associated insertion instructions 15 as customized to the known trigger events 22 of the respective sport venue 18 of each of the content clients 14.

Referring to FIG. 3, shown is an example configuration of the content server 12, including a supplementary content video library 200 that contains one or more insertion schedules 202 (those schedules that define the macro level for network wide aggregation of all sporting events 17 for all sport venues 18 for all defined trigger events 22) for corresponding supplementary video contents 16a,b, a receiver module 204 for receiving insertion reports 206 from the content clients 14a,b that contain information concerning the actual play statistics of the supplementary video content 16a,b as inserted in the broadcast 20a,b by the production equipment 26 of the sport venue 18a,b (see FIG. 1), a transmission module 208 for sending insertion instructions 15a,b obtained from the insertion schedule(s) 202 and the associated supplementary video content 16a,b to specified content clients 14a,b of the sport venue(s) 18a,b, a scheduler module 210 for generating the insertion instructions 15a,b from the insertion schedule(s) 202 for each grouping of the supplementary video content 16a,b obtained from the supplementary video content 16 of the library 200, and a report generation module 212 for generating the reports 24 from the received insertion reports 206 for receipt by the content providers 21. Accordingly, the supplemental video content 16 across the environment 10 is logistically managed centrally by on or more of the content servers 12, who receive, schedule and distribute the supplemental video content 16. However the act of actually inserting supplemental video content 16 into the TV production broadcast 20 is controlled locally by the member sport venue 18, via the content client 14.

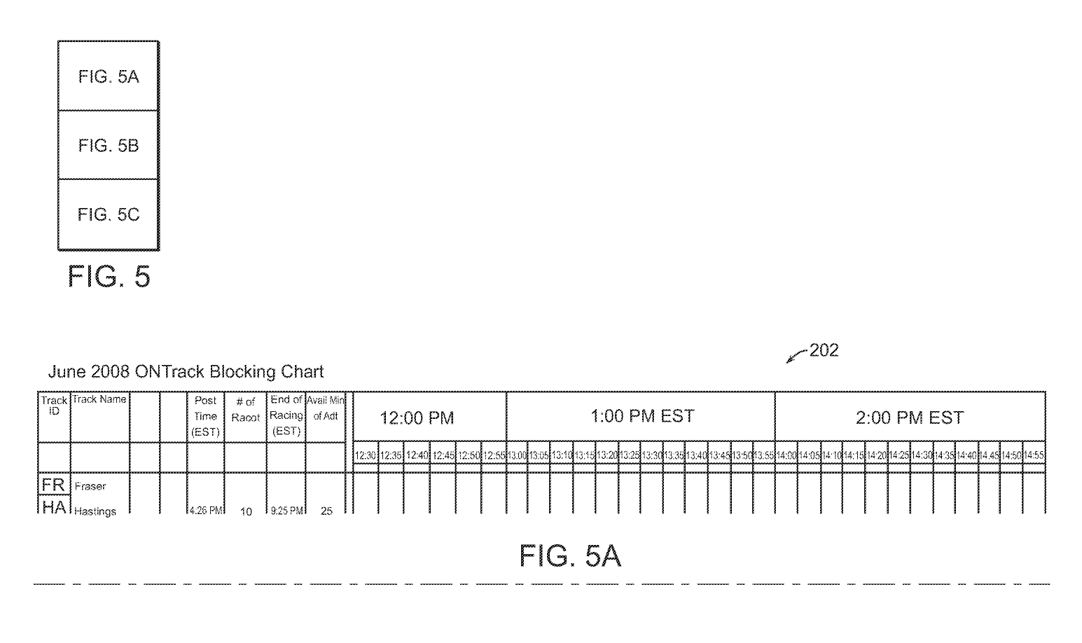

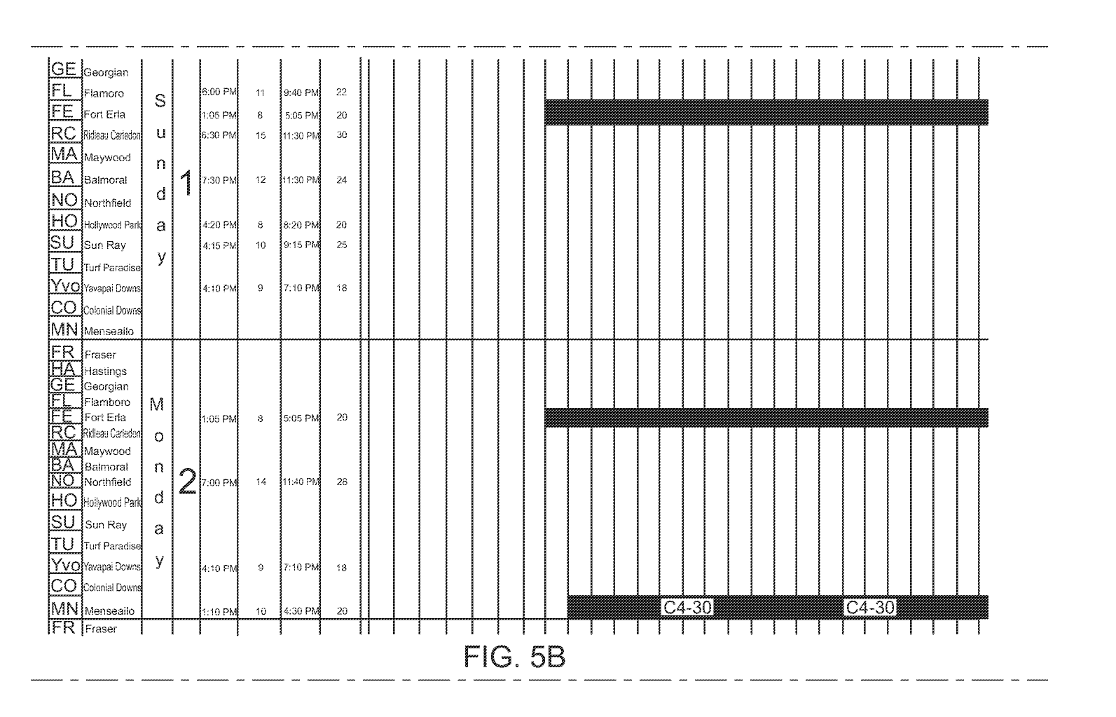

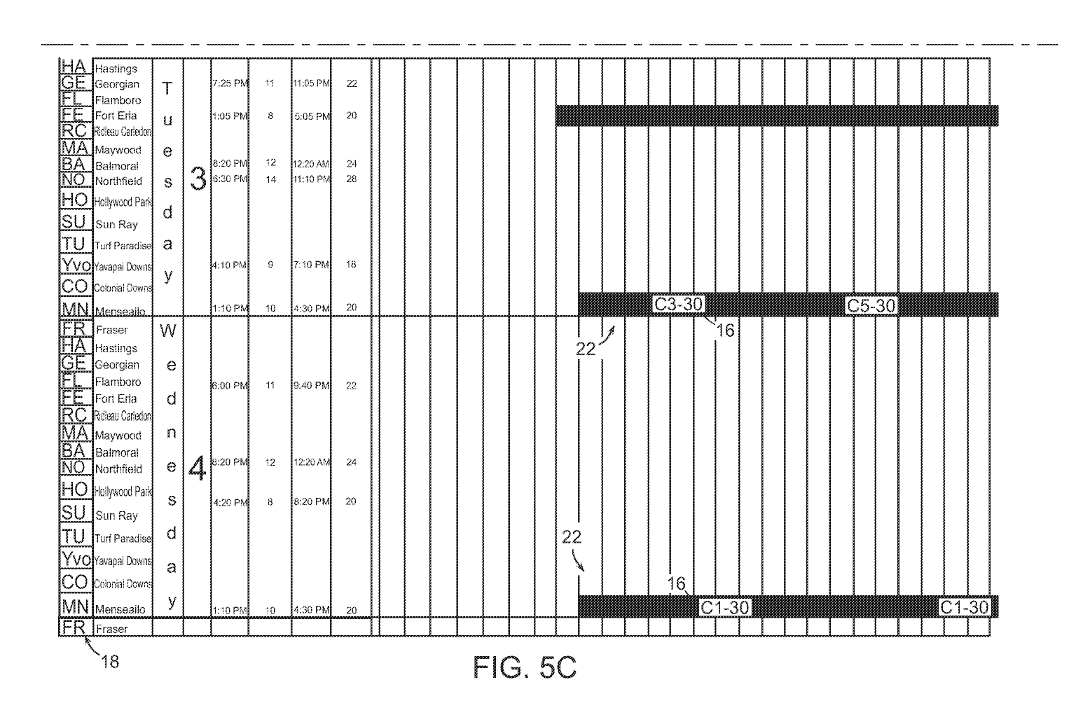

Referring to FIG. 5, shown is an example of the network insertion schedule 202 for a plurality of sports venues 18 that indicates an anticipated post time, an anticipated number of races, the anticipated end of racing, the anticipated number of available minutes for play of the supplementary video content 16, as well as specified trigger events 22 and associated supplementary video content 16. It is from this aggregated network schedule 202 that the scheduler module 210 generates the sport venue insertion instructions 15 (of the associated video content 16) for each of the sport events 17 for each of the sport venues 18

### Scheduler Module 210

Referring to FIG. 3, the scheduler module 210 is configured to generate the insertion instructions for any given sport venue 18, based on the anticipated number of sporting events 17 scheduled to take place at the sport venue 18 for a given time period (e.g. daily, weekly, monthly, or other appropriate grouping of days). It is recognised that the network insertion schedule(s) 202 can represent the combined scheduling of all sporting events 17 (at a plurality of individual sport venues 18) that the individual supplementary video content 16 (e.g. one or more advertisements) are to be played (e.g. inserted in to the broadcasts 20), as well as the particular trigger events 22 for each of the sporting events 17 that are used to position the respective supplementary video content 16 in the live video broadcast 20 produced by each of the sport venues 18.

For example, on a weekly basis, the scheduler module 210 can generate a set (e.g. seven) of daily sport venue insertion instructions 15 (e.g. play list including name of supplementary video content 16, sporting event(s) 17 for insertion, and trigger event(s) 22 in the specified sporting event(s) 17 for coordinating insertion of the associated supplementary video content 16) and then upload the sport venue insertion instructions 15 and/or the supplementary video content 16 via the transmit module 208 to the corresponding content client 14, over the network 11. For example, an email can be used to send the weekly sport venue insertion instructions 15 schedule to the technical director of the sport venue 18.

It is recognised that the supplementary video content 16 and the associated sport venue insertion instructions 15 may be sent separately or together from the content server 12 to the content client 14, as desired. For example, additional supplementary video content 16 and/or sport venue insertion instructions 15 can be sent to the content client 14 as dynamic modifications to the originally transmitted supplementary video content 16 and/or sport venue insertion instructions 15. One example of this is where the content provider 21 desires a change in the content of the supplementary video content 16 (e.g. a different version of an advertisement) and/or the play location (as specified by the trigger event 22) in the sporting event 17.

The sport venue insertion instructions 15 are used by the environment 10 to specify what sporting events 17 (e.g. races) will contain which supplementary video content 16 (e.g. ads) and which locations (e.g. race cycle) in the sporting event 17 the supplementary video content 16 are to be inserted, as defined by one or more of the trigger events 22. For example, the sport venue insertion instructions 15 may include trigger events 22 that indicate that an ad 16 is to be played after morning line odds and before post parade, or after race replay and before winners circle, or after winners circle and before order of finish. The before mentioned trigger events 22 are discussed as examples only.

The use of the trigger events 22 is to facilitate optimum or otherwise desired placement of the video content 16 in specified spots/points in the sport event 17, as it is understood that the number of people watching a given video content 16 depends on where in the sporting event 17 (e.g. race cycle) the video content 16 is placed. For example, there can be a number (e.g. four) pre-determined trigger events 22 of a race cycle 17. Each trigger event 22 is based on a predefined event that occurs during the sporting event 17, such as but not limited to: early information; the race itself; the winners circle; the race replay; etc. For each sporting event 17, a specific video content 16 (e.g. one or more individual commercials/advertisements) is inserted into the broadcast 20 based on the predefined event being reached in the sporting event 17 that is associated with the trigger event 22. For example, the sport venue insertion instructions 15 can be configured so as to rotate each of the different video content 16 through the different specified spots/points so that each video content 16 is approximately played the same number of times in each specified spot/point of the sporting event 17. It is recognised that content providers 21 can have their video content 16 assigned/associated (via the presence of the corresponding trigger event 22 in the sport venue insertion instructions 15) to a higher impact spot/point of the sporting event 17 for a premium price.

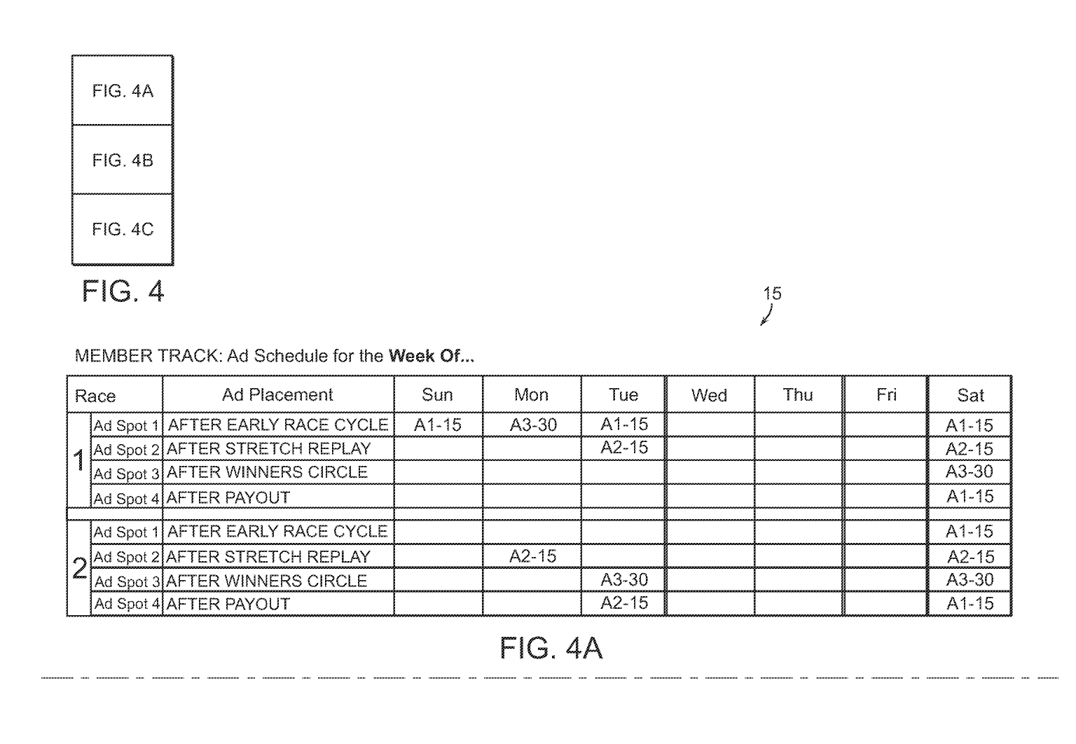

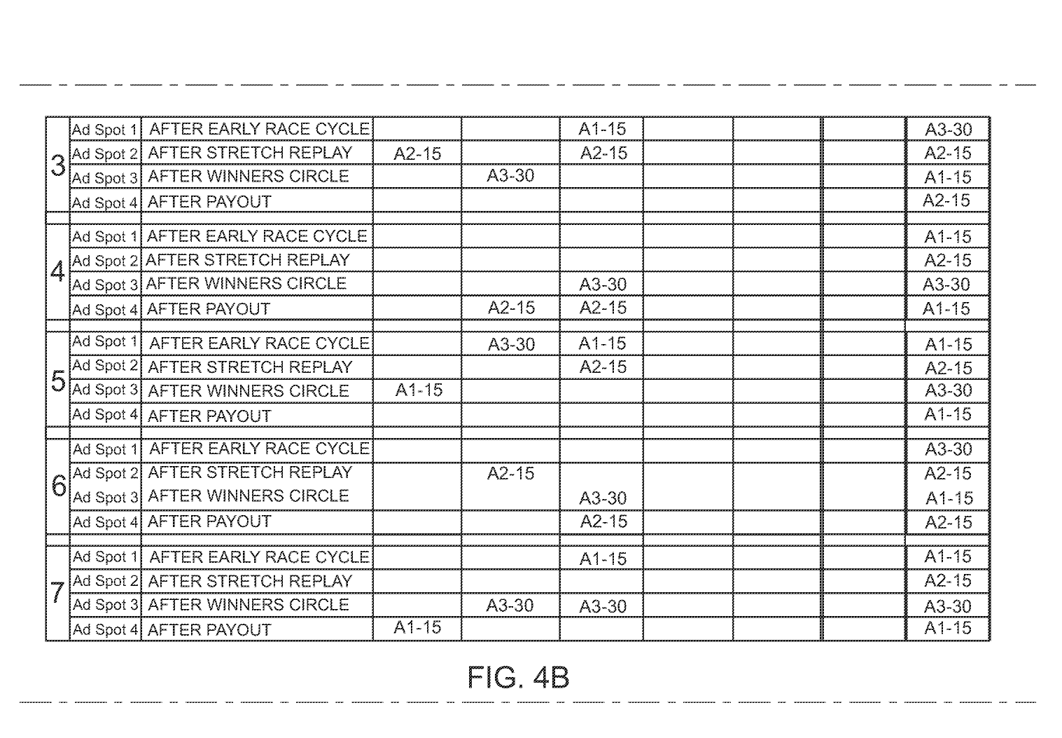

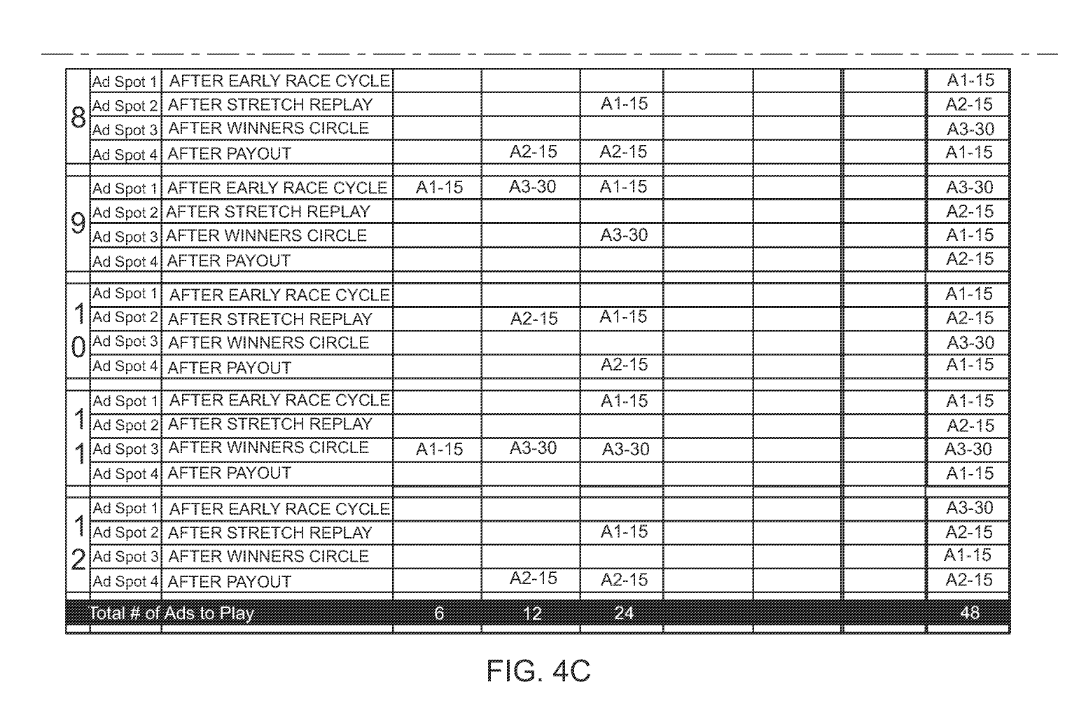

Referring to FIG. 4, shown are example sport venue insertion instructions 15, which defines trigger events 22 and corresponding sport events 17 for a particular sport venue 18. The example, for illustrative purposes only, is for a racetrack that schedules ads for all the race days in the upcoming week, e.g. for the week beginning on the following Monday and ending seven days later on a Sunday. FIG. 4 shows an increasingly complex ad 16 play list over the week. For instance, Sunday illustrates the situation where there is only one ad 16 to be played at a required frequency of play of once every other race 17 only. Monday indicates a situation where two different ads 12 are to be played in alternating races 17 at different points in the race cycle (e.g. different trigger events 22) such that each race 17 in that race 17 day has an ad 16. Tuesday shows a schedule with two ads 16 per race 17 for every race 17 while Saturday is a situation where the operation is at much higher capacity with four ad 16 campaigns running concurrently. As noted in FIG. 4, the reference labels of A1-15, A3-30, A5-60 etc. indicate the name of the ad 16 followed by how long the ad 16 play duration is in seconds e.g. 15 seconds, 30 or 60 seconds, for example.

Accordingly, the user of the content client 14 can also be informed of the play duration of the each of the particular supplementary video content 16 defined in the sport venue insertion instructions 15, thus facilitating a judgement by the user in the case where unexpected situations (e.g. race car breakdown, crash, etc.) occur during the sporting event 17. In the case where there is only a determined small amount remaining in the playback of the video content 16, the user can decide to permit the inserted video content 16 to play to completion before switching the live broadcast 20 back the live sport content 23.

Further to the above, it is also recognised that the scheduler module 210 can provide a dynamically modified set of sport venue insertion instructions 15 (and/or modified video content 16), which can then be sent as a dynamic update to the previously received sport venue insertion instructions 15 and video content 16. It is recognised that the modified set of sport venue insertion instructions 15 (and/or modified video content 16) can include modified parameters such as but not limited to: the number/location of spots and corresponding trigger events 22; and the number, length and type of video content 16 to be played within these spots. The modification of the sport venue insertion instructions 15 (and/or modified video content 16) can be a result of communications received by the content server 12 from the content provider 21, such as but not limited to feedback/instructions from ad agencies, advertisers, and member tracks. The module 210 can be configured or otherwise instructed to generate the dynamic updates to the sport venue insertion instructions 15 and/or video content 16, based on analysis of the insertion reports 206 received from the sport venues 18, as further described below.

At any given point in time the available video content 16 inventory and the scheduling of their placement in the broadcasts 20 can be dependent on and varies with the number and type of environment 10 member sport venues 18 running live sporting events 17 at that time.

### Receiver Module 204

The receiver module 204 can be part of the network connection interface 402 (see FIG. 8) of the device 101 operating the content server 12. The module 204 can communicate synchronously or asynchronously with the device 101 of the content client 14 and the content provider 21 over the network 11. The receiver module 204 receives the insertion reports 206 from the content clients 14 that contain information concerning the actual play statistics of the supplementary video content 16 (e.g. as inserted in the broadcast 20 by the production equipment 26 of the sport venue 18), as well as any production problems being experienced by the production equipment 26, the content client 14 (e.g. loss of network 11 connection or other operation malfunction), and/or unforeseen scheduling difficulties of the sporting event 17. Based on the information contained in the insertion reports 206, the scheduling module 210 can revised in near real-time what video content 16 gets played and when at the sport venue 18.

For example, in the event of a deviation of the video content 16 insertion as specified in the sport venue insertion instructions 15 and/or any desired changes to the video content 16, modified video content 16 and/or sport venue insertion instructions 15 can be dynamically generated by the scheduler module 210 and then sent as dynamic updates to a single, many, or all member sport venues 18 of the network 11 (e.g. in a matter of a few minutes). The dynamic updates can include changes such as but not limited to: subject matter of the video content 16; ordering of the video content 16 within a particular spot/location/point of the sports event 17 as identified by the corresponding trigger event 22; and/or positioning of the video content 16 within one or more sporting events 17 at the sport venue(s) 18. Like any video content 16, the actually playing of the video content 16 and its positioning within the sporting events 17 is dependent on the actions of the remote TV production staff of the sport venue 18 as coordinated by the content client 14.

### Transmit Module 208

The transmit module 208 can be part of the network connection interface 402 (see FIG. 8) of the device 101 operating the content server 12. The module 208 can also communicate synchronously or asynchronously with the device 101 of the content client 14 and the content provider 21 over the network 11. The transmission module 208 sends the generated sport venue insertion instructions 15 obtained from the network insertion schedule(s) 202 and the associated supplementary video content 16 to specified content clients 14 of the sport venue(s) 18a. Further, in the event of a deviation of the video content 16 insertion as specified in the sport venue insertion instructions 15 and/or any desired changes to the video content 16, modified video content 16 and/or sport venue insertion instructions 15 can be dynamically generated by the scheduler module 210 and then sent as dynamic updates to a single, many, or all member sport venues 18 of the network 11 (e.g. in a matter of a few minutes). Further, it is recognised that module 208 can be used to contact directly the TV Production room of each member sport venue 18, in order to confirm such dynamic updates as being received and understood by the person(s) operating the TV production equipment 16 and the content client 14.

### Report Generation Module 212

The report generation module 212 is configured for generating the reports 24, based on information contained in the received insertion reports 206. The generated reports 24 are sent over the network 11, for receipt by the content providers 21.

### Content Client 14

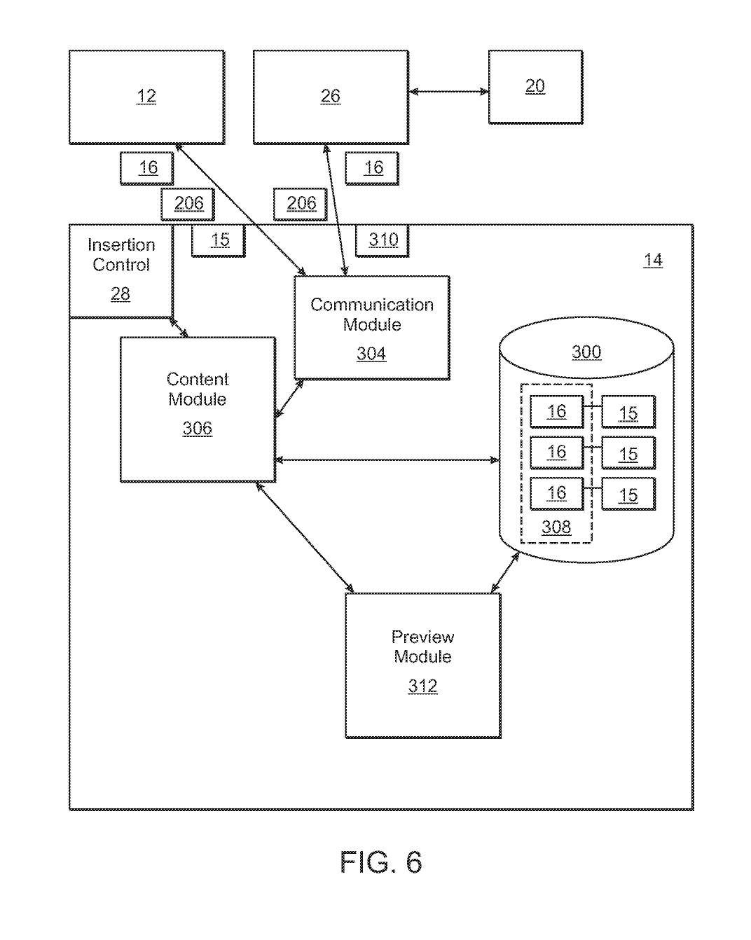

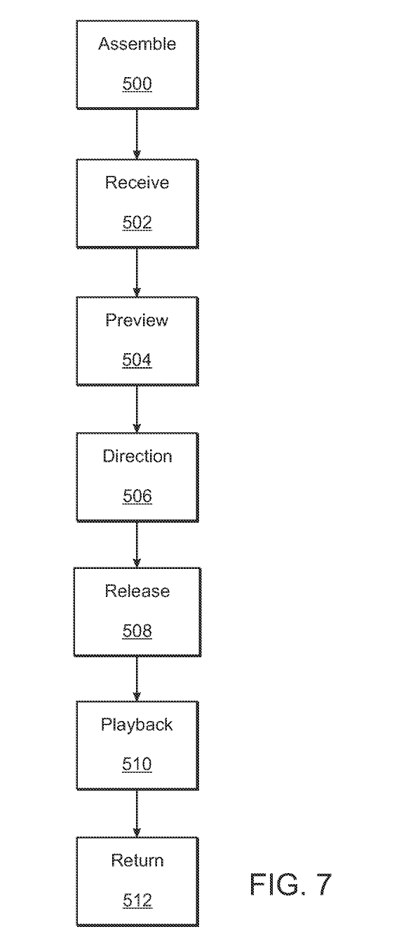

Referring to FIGS. 1 and 6, the content servers 14 receive recorded supplementary video content 16 (e.g. commercials) and related sport venue insertion instructions 15 from the content servers 12 for subsequent insertion of the supplementary video content 16 into the live video broadcasts 20 of sporting events 17 held at the sport venues 18. The video broadcasts 20 include sporting content 23 and inserted supplementary video content 16 placed at defined trigger events 22 (see FIG. 2) of the sporting event 17. The sport venue 18 also has video production equipment 26 (e.g. cameras, control panel etc.) for producing the live video stream broadcasts 20 (including synchronized audio content) of the various sporting events 17 taking place on any particular day, such that the content client 14 coordinates the supply of the video content 16 to the production equipment 26 for inclusion in the broadcast 20. The content client 14 provides for the production user to retain manual/semiautomatic control over the production of the video broadcast 20. The video content 16 will become “live” (e.g. included in the broadcast 20 in place of or in tandem with the ongoing sport content 23 of the current sporting event 17—see FIG. 3) only when the insertion control 28 is initiated by the user of the content client 14 (e.g. technical director) followed by the user or other user switching to the played/supplied video content 16 via the control panel of the production equipment 26. Once the video content 16 sequence associated with the corresponding trigger event 22 has been completed the user switches the production broadcast 20 back to the live simulcast signal of the sport content 23 being captured by the cameras of the production equipment 26. The content client can be configured to release the video content 16 such as but not limited to: as a playback video stream; and as a video file configured for playback on video equipment of the production equipment 26.

It is recognised that the content client 14 can be considered as an integrated component of the production equipment 26 or as a separate piece of equipment that communicates with the production equipment 26 via a production network coupled to the production equipment 26, as desired. In any event, the live TV production broadcast 20 into which video content 16 are inserted is operated & controlled locally by the member sport venues 18 and the content server 12 has indirect control of the insertion through supplying of the associated sport venue insertion instructions 15 and through analysis of the insertion reports 206. Further, the basis of the environment 10 is that the video content 16 (e.g. commercial ads) are inserted into the television production broadcast 20 by the Television production staff who are physically located in the TV production room at the sport venue 18 and/or are remote to the sport venue 18 (or at least the TV production room) but are able to view the actions of the live sporting event 17 (e.g. via remote monitor) and are able to initiate the submission of the video content 16 via the content client 14 through actuation of the insertion control 28.

Modules of the Content client 14

Referring again to FIG. 6, one or more supplementary video contents 16 can be inserted between adjacent broadcasted segments of the live sporting content 23 (see FIG. 2), according to the sport venue insertion instructions 15 and/or the instruction of the user of the content client 14 via a communication module 304 coupled to the production equipment 26. It is recognised that the video production equipment 26 is used to switch the video stream of the broadcast 20 between captured video 23 of the sporting event 17 and the supplementary video content 16 supplied by the content client 14.

The content client 14 coordinates the initiation of the switching of the supplementary video content 16 feed between broadcast segments (e.g. sport content 23) of the sport event 17, based on the specified trigger events 22 (see FIG. 2) in the respective sport venue insertion instructions 15 associated with the supplementary video content 16. The use of the insertion control 28 (e.g. a start button) by the production user can initiate a content module 306 to access the sport venue insertion instructions 15 from the storage 300 and to submit the associated video content 16 to the communication module 304 for preview 403 on the user interface 402 and/or submission to the production equipment for insertion (see FIG. 8) into the broadcast 20 by the production equipment 26. It is recognised that a queue 308 (e.g. first in first out—FIFO) can be used (optionally) to manage the order of insertion of the video content 16 into the video broadcast 20. The video content 16 (e.g. ads) received from the content server 12 (e.g. for each day) can be queued in the queue 308 in the sequence in which they are to be played in the broadcast 20 of a particular sporting event 17. For example the communication module 304 can receive instructions from the production equipment 26 and/or the production user (e.g. via the user interface 402—see FIG. 8) to select or otherwise queue the video content 16 for a specified sporting event 17 or sporting events 17. In this case, the content module 306 analyses the sport venue insertion instructions 15 and selects the proper sequence of video content 16 to place in the queue 308, based on the order of the trigger instructions 22 associated with the video content 16 for that sporting even(s) 17. Accordingly, activation of the insertion control 28 would provide/play the next available video content 16 in the queue 308 to the production equipment 26. It is recognised that the preview 403 of the video content 16 can include as well a preview of the associated insertion instructions 15 or may not include a preview of the associated insertion instructions 15. In the case of the associated insertion instructions 15 not being included in the preview 403, the user would have access to an order list of insertion instructions 15 (e.g. a separate communication such as an email, facsimile copy, telephone instructions, etc.) that match the list order of the video content 16 in the preview 403.

The communication module 304 can be used to record the play history 310 of the supplementary video content 16, including information such as but not limited to: the time and date of the supplementary video content 16 broadcast; at which trigger event 22 (see FIG. 2) the video content 16 was inserted into the live broadcast 20; and/or whether the supplementary video content 16 was played to completion (e.g. the playback of the recorded supplementary video content 16 was not interrupted). The play history 310 for each of the video content 16 is communicated to the content server 12 as the insertion report 206.

For example, the supplementary video content 16 will become inserted into the broadcast 20 only when the insertion control 28 of the content client 14 (e.g. a set top box (STB)) in the production control room of the sport venue 18 is activated (e.g. pressed) by the technical director (e.g. production user), followed by the technical director switching/selecting (e.g. via a control panel of the production equipment 26) the supplementary video content 16 in substitution of or in tandem with the sports content 23 of the ongoing sporting event 17. Once the specified (as per the sport venue insertion instructions 15) supplementary video content 16 sequence has been completed, the technical director switches the production content of the video broadcast 20 back to the live sports content 23 of the ongoing sporting event 17. It is recognised that in the case of an occurrence of an unscheduled event in the sporting event 17, the insertion control 28 can also be used to halt/skip or otherwise suspend the playing of the supplementary video content 16 and the technical director can reintroduce (e.g. select) the sports content 23 of the ongoing sporting event 17 to the video broadcast 20.

The insertion control 28 is configured to operate the release of the video content 16 so as to, for example, halt or otherwise suspend the playback of the video, reintroduce a previously released video content 16 to the video broadcast 20, and skip over one or more videos from a queued list of the set of pre-recorded video content 16. It is recognised that the insertion control 28 can be a button (or other mechanically and/or electrically actuated physical control mechanism) configured for the sole purpose of coordinating the release of the video content 16 to the production equipment 26 or can be an interface for receiving specific instructions for each function of the insertion control 28 (e.g. a number of different commands such as halt, play, stop, skip, etc.). It is recognised that the insertion control can be incorporated with the user interface 402 (see FIG. 8) and/or have any of the features of the interface 402, as described below. further, it is recognised that the insertion control 28 can be embodied in hardware, software, or a combination thereof. In any event, it is recognised that the insertion control 28 is operated by the user (e.g. of the production equipment 26) and is used to facilitate the release (to the production equipment 26) of the video content 16 assigned to the trigger event 22 matching the current sport activity of the live sporting event 17

Referring again to FIG. 6, the content client 14 also has a preview module 312 for coordinating the playing/switching of the video content 16 into the broadcast 20. Accordingly, via the preview module 312, the user of the content client 14 can also be informed of the play duration of the each of the particular supplementary video content 16 defined in the sport venue insertion instructions 15, thus facilitating a judgement by the user in the case where unexpected situations (e.g. race car breakdown, crash, etc.) occur during the sporting event 17. In the case where there is only a determined small amount of time remains in the playback of the video content 16, the user can decide to permit the inserted video content 16 to play to completion before switching the live broadcast 20 back the live sport content 23. The display of the play duration (pre, during, and/or post play) can be displayed in the preview 403 on the user interface 402 of he device 101.

Further to the above, it is also recognised that the communications module 304 can receive a dynamically modified set of sport venue insertion instructions 15 (and/or modified video content 16), which can then be processed by the content module 306 as a dynamic update to the previously received sport venue insertion instructions 15 and video content 16. It is recognised that the modified set of sport venue insertion instructions 15 (and/or modified video content 16) can include modified parameters such as but not limited to: the number/location of spots and corresponding trigger events 22; and the number, length and type of video content 16 to be played within these spots. The modification of the sport venue insertion instructions 15 (and/or modified video content 16) can be a result of communications received by the content server 12 from the content provider 21, such as but not limited to feedback/instructions from ad agencies, advertisers, and member tracks. The module 306 can be configured to process the dynamic updates of the sport venue insertion instructions 15 and/or video content 16, in order to modify the sport venue insertion in instructions 15 stored in the storage 300 as well as to change the queued sequence (e.g. playlist of video content 16) by actions such as but not limited to: reorder the video content 16 in the queue 308; insert new video content 16 in the queue 308; and/or delete existing video content 16 in the queue 308.

The content client 14 uses the storage queue 308 for storing a sequence of the videos of the set of pre-recorded video content 16 according to a sequential order associated with the trigger events assigned to each of the videos.

One example operation of the content client 14 is where the Daily Play List (e.g. sport venue insertion instructions 15 and associated video content 16) is sent electronically, as respective customized daily play lists, to the content client 14 at each member sport venue 18, to identify which video content 16 (e.g. saved in the library an/or included in electronic transmission) are to be played for a given day. The content client 14 will automatically queue (e.g. via the content module 306 in processing of the sport venue insertion instructions 15) the first video content 16 to be played and will display this on the preview 403 screen. Once the video content 16 is played, the next video content 16 in the sequence will be automatically queued and similarly this will be displayed on the preview 403 screen. As well, other identifying information of the previewed video content 16 can also be displayed in the preview 403 screen, as described above, such as the name &/or description of the video content, the duration of play of the queued video content 16 and the associated trigger event 22. This means that all the production staff does is to push the play button (e.g. activate the insertion control 28) in the appropriate sporting event 17 at the trigger event 22 specified, and for the technical director to switch the played/submitted video content 16 to the live production broadcast 20. It is recognised that the preview 403 screen can display one or more of the video content 16 and their associated identifying information, as desired.

Accordingly, the identifying Information displayed in the preview 403 display of the content client 14 can include information such as but not limited to: name or other identification of the individual content 16 to be played/inserted; the duration/length of the individual content 16; time remaining/elapsed of the playback of the individual video content 16 currently inserted in to the broadcast 20; the trigger event 22 associated with the individual video content 16; the sporting event 17 for the individual video content 16; and/or the number of remaining individual video content 16 for a particular sporting event 17.

In an alternative embodiment, a plurality of trigger events 22 can be displayed with each of the video content 16 listed in the queue 308 on the preview 403 display. The user of the content client 14 would have the option of selecting one of the video content 16 that has the trigger event 22 that matches the current opportunity spot/point in the sporting event 17 and initiate the insertion control 28 to play that selected video content 16 from those listed. Upon selection, for example, (or otherwise indicated or being notified that further play opportunities for that trigger event 22 are not available), the content module 306 can update the trigger events 22 listed with the remaining video content 16 in the preview 403 display, and so on until the playlist is exhausted for that particular sporting event 17 (or collection of sporting events 17 such as a for a given day).

One example of this embodiment is where the playlist had three video content A1, A2, A3, with corresponding trigger events of T1, T2, T3 associated with the video content A1,A2,A3 and associated sporting events of SE1, SE2. The example playlist is as follows: A1-T1,T2,SE1,SE2; A2-T1,T3,SE1,SE2; and A3-T1,T2,T3,SE1. Accordingly, A1 can be played in either SE1 and/or SE2 at T1 and/or T2, etc. As the appropriate video content 16 is selected from the list in the queue 308, the content module 306 updates the list in the queue 308 to accommodate for the trigger points 22 and/or sporting events 17 remaining. For example, playing A1 in T1 for SE1 (where no further opportunity for playback in T1 of SE1 exists) could cause the playlist to be updated as: A2-T3,SE1 or T1,T3,SE2; and A3-T2,T3,SE1, thus denoting that video content A2 only has one more opportunity remaining to be played in SE1 and A3 has two remaining opportunities to be played in SE1. Accordingly, the playlist of the queue 308 could be updated to show the remaining video content 16 and opportunities (e.g. for remaining trigger events 22 for the current and/or future sporting events 17) for playback based on previously selected video content 16.

### Operation of the Environment 10

Referring to FIGS. 1,2, 6, 7, the operation of the environment 10 is shown by example, for providing a set of pre-recorded video content 16 for inclusion into one or more locations in the video broadcast 20 having sport content 23 of the live sporting event 17. The video broadcast 20 is produced during the live sporting event 17. At step 500, the content server 12 assembles the set of pre-recorded video content 16 and the set of associated insertion instructions 15 for the particular sport venue 18, according to the sporting event(s) 17 to be hosted by the sport venue 18 for the time period (e.g. race cycle) covered by the insertion instructions 15. The insertion instructions 15 have a plurality of insertion information including at least one predefined trigger event 22 assigned to each identified video in the video content 16, such that the predefined trigger event 22 is defined as a sport activity known to occur in the live sporting event 17.

At step 502, the content client 14 receives the set of pre-recorded video content 16 having an order that corresponds with the insertion instructions 15 and optionally the set of associated insertion instructions 15. It is recognised that the order of the videos of the video content 16 can be defined as a numerical order, can be defined by labels that correspond with the individual trigger events 22 of the insertion instructions 15, or a combination thereof. Accordingly, the sequential playback/release order of the videos of the video content 16 can be predefined by the content server 12 (e.g. numerically such as first video followed by second video, etc.) or can be configured so as to contain labels that match up with the trigger events 22 of the associated insertion instructions 15. In the case of the match up, the content module 306 of the content client 14 can be used to compare the labels of the videos of the video content 16 with the order of the trigger events 22 of the insertion instructions 15 so as to put the videos in a playlist/release order that matches the order of the trigger events 22 (e.g. the trigger events 22 can be specified for multiple locations in each sporting event 17 that are to be hosted in a specified sport event 17 order for a given time period at the sport venue 18).

At step 504, the communications module 304 indicates (e.g. via preview 403 display—see FIG. 8) selected contents of the set of pre-recorded video content 16 and the set of associated insertion instructions 15 to a user of the production equipment 26. At step 506 the content client 12 is directed by the insertion control, operated by the user, to initiate the release of a video of the set of pre-recorded video content 16 to the production equipment 26 for use in producing the video broadcast 20. It is recognised at step 506 that the insertion control is operated based on the video having an assigned trigger event 22 (evident by the insertion instructions 15) matching a current sport activity of the live sporting event 17 known to the user. At step 508 the production equipment 26 is used to insert the video into the video broadcast 20 at a location corresponding to the current sport activity defined by the trigger event 22 and at step 510 the video is played to completion (or halted if necessary). At step 512, once the playback of the pre-recorded video(s) is/are completed, the broadcast 20 is again centered/returned on the sports content 23 of the live sporting event 17.

In view of the above, the storage queue 308 can be used to storing a sequence of the videos of the set of pre-recorded video content 16 according to a sequential order associated with the trigger events 22 assigned to each of the videos.

Further the content client 14 can be configured for amending the contents of the storage queue 308 based on the received update material, such that the amendment can be selected from the group comprising: reordering of the videos in the storage queue 308; adding an additional video of the update material to the storage queue 308; deleting an existing video from the storage queue 308; changing the assigned trigger event 22 of at least one of the videos in the storage queue 308; and changing an assigned sporting event 17 of at least one of the videos in the storage queue 308.

Further, the content server 12 is further configured to receive an insertion report 206 from the content client 14, the insertion report 206 having information selected from the group comprising: an operational status of the content client 14; a list of videos of the pre-recorded video content 16 that were inserted into the video broadcast 20; a track name of the sport venue 18; a commercial name of the sport venue 18; a date and time said video was played; an actual event location of the sporting event 17 that said video was inserted; an indication as to whether said video was played to completion; a list of videos of the pre-recorded video content 16 that remain in the storage queue 308; a list of sporting events yet to be held at the sport venue 18; a list of sporting events 17 already held at the sport venue 18; a list of cancelled sporting events 17; a list of delayed sporting events 17; and a change in predefined trigger events 22 for one or more of the sporting events 17 yet to be held at the sport venue.

Further, it is also recognised that the video content 16 transmitted to the content client 14 also has a sequential order for each of the videos included, such that the order of the videos corresponds with the insertion instructions 15 (in particular the order of the trigger events 22 associated with each of the videos). Accordingly, further to the above, an alternative embodiment is that the video content 16 is transmitted directly to the content client 16 while the corresponding insertion instructions 15 are transmitted (e.g. via email, facsimile, phone, or other communication, etc.) for receipt by the user of the content client 14.

### Computing Devices 101

Referring to FIGS. 1 and 8, each of the above-described components of the environment 10, e.g. the content server 12, the content client 14, and the content provider 21 can be implemented on one or more respective computing device(s) 101. The devices 101 in general can include a network connection interface 400, such as a network interface card or a modem, coupled via connection 418 to a device infrastructure 404. The connection interface 400 is connectable during operation of the devices 101 to the network 11 (e.g. an intranet and/or an extranet such as the Internet), which enables the devices 101 to communicate with each other as appropriate. The network 11,13 can support the communication of the sport venue insertion instructions 15, the video content 16, the reports 24, 206 and the broadcast 20 between the components of the environment 10. It is recognised that the functionality of any of the components can be hosted on the user device 101, hosted on a device 101 remote to the user via the network 11,13 or a combination thereof.

Referring again to FIG. 8, the devices 101 can also have a user interface 402, coupled to the device infrastructure 404 by connection 422, to interact with a user. The user interface 402 is used by the user of the device 101 of the content client 14 to view and interact with the preview display 302, for example. The user interface 402 can include one or more user input devices such as but not limited to a QWERTY keyboard, a keypad, a track-wheel, a stylus, a mouse, a microphone and the user output device such as an LCD screen display and/or a speaker. If the screen is touch sensitive, then the display can also be used as the user input device as controlled by the device infrastructure 404. For example, the user interface 402 for the devices 101 used by the users can be configured to interact with a web browser (e.g. part of the executable instructions 407) to check on the operation of the content client 14 as well as to request and receive the dynamically updated sport venue insertion instructions 15 and/or video content 16.

Referring again to FIG. 8, operation of the devices 101 is facilitated by the device infrastructure 404. The device infrastructure 404 includes one or more computer processors 408 and can include an associated memory 410 (e.g. a random access memory). The computer processor 408 facilitates performance of the device 101 configured for the intended task through operation of the network interface 400, the user interface 402 and other application programs/hardware 407 of the device 101 by executing task related instructions. These task related instructions can be provided by an operating system, and/or software applications 407 located in the memory 410, and/or by operability that is configured into the electronic/digital circuitry of the processor(s) 408 designed to perform the specific task(s). Further, it is recognized that the device infrastructure 404 can include a computer readable storage medium 412 coupled to the processor 408 for providing instructions to the processor 408 and/or to load/update client applications 407 if locally accessed. The computer readable medium 412 can include hardware and/or software such as, by way of example only, magnetic disks, magnetic tape, optically readable medium such as CD/DVD ROMS, and memory cards. In each case, the computer readable medium 412 may take the form of a small disk, floppy diskette, cassette, hard disk drive, solid-state memory card, or RAM provided in the memory module 410. It should be noted that the above listed example computer readable mediums 412 can be used either alone or in combination. The device memory 410 and/or computer readable medium 412 can be used to store the sport venue insertion instructions 15 and the video content library 200,300.

Further, it is recognized that the computing devices 101 can include the executable applications 407 comprising code or machine readable instructions for implementing predetermined functions/operations including those of an operating system, a web browser, for example. The processor 408 as used herein is a configured device and/or set of machine-readable instructions for performing operations as described by example above. As used herein, the processor 408 may comprise any one or combination of, hardware, firmware, and/or software. The processor 408 acts upon information by manipulating, analyzing, modifying, converting or transmitting information for use by an executable procedure or an information device, and/or by routing the information with respect to an output device. The processor 408 may use or comprise the capabilities of a controller or microprocessor, for example. Accordingly, any of the functionality of any of the modules (and subsets thereof) of the content server 12 and the content client 14 may be implemented in hardware, software or a combination of both. Accordingly, the use of a processor 408 as a device and/or as a set of machine-readable instructions is hereafter referred to generically as a processor/module for sake of simplicity.

It will be understood that the computing devices 101 of the users may be, for example, personal computers, personal digital assistants, and set top boxes. Further, it is recognised that each computing device 101, although depicted as a single computer system, may be implemented as a network of computer processors, as desired.

It will be understood by a person skilled in the art that the memory 410 storage described herein is the place where data is held in an electromagnetic or optical form for access by a computer processor. In one embodiment, storage means the devices and data connected to the computer through input/output operations such as hard disk and tape systems and other forms of storage not including computer memory and other in-computer storage. In a second embodiment, in a more formal usage, storage is divided into: (1) primary storage, which holds data in memory (sometimes called random access memory or RAM) and other “built-in” devices such as the processor's L1 cache, and (2) secondary storage, which holds data on hard disks, tapes, and other devices requiring input/output operations. Primary storage can be much faster to access than secondary storage because of the proximity of the storage to the processor or because of the nature of the storage devices. On the other hand, secondary storage can hold much more data than primary storage. In addition to RAM, primary storage includes read-only memory (ROM) and L1 and L2 cache memory. In addition to hard disks, secondary storage includes a range of device types and technologies, including diskettes, Zip drives, redundant array of independent disks (RAID) systems, and holographic storage. Devices that hold storage are collectively known as storage media.

A database is a further embodiment of memory 410 as a collection of information that is organized so that it can easily be accessed, managed, and updated. In one view, databases can be classified according to types of content: bibliographic, full-text, numeric, and images. In computing, databases are sometimes classified according to their organizational approach. As well, a relational database is a tabular database in which data is defined so that it can be reorganized and accessed in a number of different ways. A distributed database is one that can be dispersed or replicated among different points in a network. An object-oriented programming database is one that is congruent with the data defined in object classes and subclasses.

Computer databases typically contain aggregations of data records or files, such as sales transactions, product catalogs and inventories, and customer profiles. Typically, a database manager provides users the capabilities of controlling read/write access, specifying report generation, and analyzing usage. Databases and database managers are prevalent in large mainframe systems, but are also present in smaller distributed workstation and mid-range systems such as the AS/400 and on personal computers. SQL (Structured Query Language) is a standard language for making interactive queries from and updating a database such as IBM's DB2, Microsoft's Access, and database products from Oracle, Sybase, and Computer Associates.

Memory is a further embodiment of memory 410 storage as the electronic holding place for instructions and data that the computer's microprocessor can reach quickly. When the computer is in normal operation, its memory usually contains the main parts of the operating system and some or all of the application programs and related data that are being used. Memory is often used as a shorter synonym for random access memory (RAM). This kind of memory is located on one or more microchips that are physically close to the microprocessor in the computer.

We claim:

1. A system for providing a set of pre-recorded video content for inclusion into one or more locations in a video broadcast having sport content of a live sporting event, the video broadcast for production during the live sporting event, the system comprising:
a content server for assembling the set of pre-recorded video content and a set of associated insertion instructions, the insertion instructions having a plurality of insertion information including at least one predefined trigger event assigned to each identified video in the video content, the predefined trigger event defined as a sport activity known to occur in the live sporting event; and
a content client configured for coupling to the content server over a communications network, the content client further configured for receiving the set of pre-recorded video content and an order of the videos of the pre-recorded video content corresponding to the set of associated insertion instructions and for indicating selected contents of the set of pre-recorded video content to a user, the content client having an insertion control operable by the user for initiating release of a video of the set of pre-recorded video content to production equipment for producing the video broadcast, the video having an assigned trigger event matching a current sport activity of the live sporting event;
wherein the production equipment inserts the video into the video broadcast at a location corresponding to the current sport activity.

2. The system of claim 1, wherein the inclusion of the video in the video broadcast is selected from the group comprising: in substitution of the live sport content; and a combined display with the live sport content.

3. The system of claim 2, wherein the content client is located at sport venue producing the video broadcast.

4. The system of claim 3, wherein the insertion control is operated by the user also located at the sport venue.

5. The system of claim 3, wherein the sport venue is selected from the group comprising: a racetrack; an arena; and a stadium.

6. The system of claim 5, wherein the sporting event is a race and the known sport activity is of a race cycle of the race is selected from the group comprising: after morning line odds and before post parade; after race replay and before winners circle; after winners circle and before order of finish; before start of the race; during the race itself; at a winners circle of the race; a replay of the race; and an interval located between pre-race information and presentation of line odds to a final race replay occurring before the pre-race information of a subsequent race.

7. The system of claim 5 further comprising an off venue location configured for receiving the video broadcast from the production equipment of the sport venue via a broadcast network.

8. The system of claim 5, wherein the broadcast network is selected from the group comprising: the communications network; a second communications network different from the communications network; and a satellite network different from the communication network.

9. The system of claim 2, wherein the content client is one of a plurality of content clients configured for coupling to the content server through the communication network, such that each of the plurality of content clients is associated with a respective sport venue hosting at least one of said live sporting event.

10. The system of claim 9, wherein the content server is further configured to generate the set of associated insertion instructions from instructions selected from schedule information, the schedule information including information on a plurality of sporting events to be held at a plurality of sporting venues and including a plurality of trigger events of each of the plurality of sporting events.

11. The system of claim 9, wherein the content server is further configured to generate the pre-recorded video content and the set of associated insertion instructions for each of the content clients to include the set of associated insertion instructions as customized to the known trigger events of the respective sport venue of each of the content clients.

12. The system of claim 9, wherein the content client is configured as selected from the group comprising: integral with the production equipment of the respective sport venue; and separate to but coupled with the production equipment of the respective sport venue via a production network coupled to the production equipment.

13. The system of claim 8, wherein the content client is further configured to release the video selected from the group comprising: as a playback video stream; and as a video file configured for playback on video equipment of the production equipment.

14. The insertion control of claim 13, wherein the insertion control 28 is further configured to operate the release of the video selected from the group comprising: halt or otherwise suspend the playback of the video; reintroduce a previously released video to the video broadcast; and skip over the video from a queued list of the set of pre-recorded video content.

15. The system of claim 14, wherein the insertion control is a button for activation by the user.

16. The system of claim 2 further comprising the content client having a storage queue for storing a sequence of the videos of the set of pre-recorded video content according to a sequential order associated with the trigger events assigned to each of the videos.

17. The system of claim 16 further comprising the content server configured for generating update material of previously transmitted said set of pre-recorded video content and set of associated insertion instructions and for transmitting the update material to the content client.

18. The system of claim 17 further comprising the content client configured for amending the contents of the storage queue based on the received update material, the amendment selected from the group comprising: reordering of the videos in the storage queue; adding an additional video of the update material to the storage queue; deleting an existing video from the storage queue; changing the assigned trigger event of at least one of the videos in the storage queue; and changing an assigned sporting event of at least one of the videos in the storage queue.

19. The system of claim 18, wherein the content server is further configured to receive an insertion report from the content client, the insertion report having information selected from the group comprising: an operational status of the content client; a list of videos of the pre-recorded video content that were inserted into the video broadcast; a track name of the sport venue 18; a commercial name of the sport venue; a date and time said video was played; an actual event location of the sporting event that said video was inserted; an indication as to whether said video was played to completion; a list of videos of the pre-recorded video content that remain in the storage queue; a list of sporting events yet to be held at the sport venue; a list of sporting events already held at the sport venue; a list of cancelled sporting events; a list of delayed sporting events; and a change in predefined trigger events for one or more of the sporting events yet to be held at the sport venue.

20. A method of providing a set of pre-recorded video content for inclusion into one or more locations in a video broadcast having sport content of a live sporting event, the video broadcast for production during the live sporting event, the method comprising:
assembling the set of pre-recorded video content and a set of associated insertion instructions, the set of pre-recorded video content having an order of the videos of the pre-recorded video content corresponding to the set of associated insertion instructions, the set of associated insertion instructions having a plurality of insertion information including at least one predefined trigger event assigned to each identified video in the video content, the at least one predefined trigger event defined as a sport activity known to occur in the live sporting event;
transmitting said set of pre-recorded video content and set of associated insertion instructions over a communications network to a sport venue having a content client configured for initiating release of a video of the set of pre-recorded video content to production equipment for producing the video broadcast;
generating update material of at least one of previously transmitted said set of pre-recorded video content or previously transmitted said set of associated insertion instructions; and
transmitting the update material to the sport venue;
wherein the production equipment inserts said video into the video broadcast at a location corresponding to the respective sport activity defined by the assigned predefined trigger event, the manner of insertion based on information contained in the update material.

21. A method for providing a set of pre-recorded video content for inclusion into one or more locations in a video broadcast having sport content of a live sporting event, the video broadcast for production during the live sporting event, the method comprising:
receiving the set of pre-recorded video content and a set of associated insertion instructions, the set of pre-recorded video content having an order of the videos of the pre-recorded video content corresponding to the set of associated insertion instructions, the insertion instructions having a plurality of insertion information including at least one predefined trigger event assigned to each identified video in the video content, the predefined trigger event defined as a sport activity known to occur in the live sporting event;
indicating selected contents of the set of pre-recorded video content to a user having knowledge of a sport activity status of the live sporting event; and
receiving instructions from an insertion control operable by the user for initiating release of a video of the set of pre-recorded video content to the production equipment for producing the video broadcast, the video having an assigned trigger event matching a current sport activity of the live sporting event;
wherein the production equipment inserts the video into the video broadcast at a location corresponding to the current sport activity.
